(19) United States
(12) Patent Application Publication
(10) Pub. No.: US 2018/0033033 A1
(43) Pub. Date: Feb. 1, 2018

(54) METHODS AND SYSTEMS OF POLLING WITH LINKED POST-VOTE ACTIONS

(71) Applicant: RE:GROUP'D MEDIA INC., Harrison, NY (US)

(72) Inventors: Lindsey Cummins, Harrison, NY (US); Nishank Khanna, Richmond Hill, NY (US)

(21) Appl. No.: 15/726,253

(22) Filed: Oct. 5, 2017

Related U.S. Application Data
(63) Continuation of application No. PCT/US17/34056, filed on May 23, 2017.
(60) Provisional application No. 62/340,454, filed on May 23, 2016.

(51) Int. Cl. G06Q 30/02

(52) U.S. Cl. CPC G06Q 30/0203; G06Q 30/0277; G06Q 30/0261; G06Q 30/0255; G06Q 30/0207

(57) ABSTRACT

Systems and methods as disclosed herein provide polls having linked post-vote actions. A polling query having two or more options is presented on a user interface (UI) of a mobile electronic device of a user. Each option presented is linked to a post-vote action. Additionally, a selection of an option from the two or more options in the polling query is received on the mobile electronic device of the user. A post-vote action that is linked to the selected option is determined. Further, the post-vote action that is linked to the selected option is presented on the UI of the mobile electronic device of the user.

### CROSS-REFERENCE

This application is a continuation application of International Application No. PCT/US17/34056, filed on May 23, 2017, which claims the benefit of priority to U.S. Provisional Patent Application No. 62/340,454, filed May 23, 2016, which is entirely incorporated herein by reference.

### BACKGROUND

As Internet access becomes increasingly available, users are increasingly exposed to web-based and mobile-based applications. Some of these applications include survey and/or polling aspects. By providing polling sessions to Internet users, companies can access information from a diverse set of users. However, polling sessions are typically focused on gaining access to a user's opinion and/or choice between various options. Interactions with a user typically end once the polling session has received the user's input on a given poll and/or survey.

The use of mobile devices in various types of mobile consumer transactions and commerce related communications is becoming more common and more complex. Mobile devices, such as cell phones, smart phones, and Personal Digital Assistants (PDAs), are typically used to facilitate polling sessions to users.

### SUMMARY

While there are polling systems and methods presently available, recognized herein are limitations associated with such systems and methods. Current polling systems may not engage a user after receiving a response after the user interacts with a given poll and/or survey. Further, current polling systems may not link post-vote actions that a user may choose so as to continue the user's experience with subject matter from the polling session. By having post-vote actions that may engage a user, companies that provide polls and/or surveys may increase user satisfaction and overall user engagement over a series of polling sessions. In particular, by providing beneficial post-vote actions, companies may gain benefit by receiving an increased amount of user input and may also benefit the user by providing desirable information that is of interest to the user. Additionally, companies may benefit by generating user interest in particular topics that are the subject of polling sessions.

The present disclosure provides systems and methods for providing polling ad units. The polling ad units provide polling pairs that link post-vote actions with polling choices. In examples, post-vote actions may include reading more about a topic, purchasing a service or object, clipping a coupon, watching a video, generating a lead, clicking through to website, or other examples. In some examples, one or more post-vote actions may be directly provided to the user. In some examples, one or more post-vote actions may be provided via links that are presented to the user. In some examples, some post-vote actions may be directly provided and some post-vote actions may be provided via links that are presented to the user. Such systems and methods advantageously enable users to quickly obtain additional information that may be beneficial to the user.

In one aspect, the invention provides a method for providing polls having linked post-vote actions. The method comprises presenting, on a user interface (UI) of a mobile electronic device of a user, a polling query having two or more options. Each option presented is linked to a post-vote action. Additionally, the method comprises receiving, on the mobile electronic device of the user, a selection of an option from the two or more options in the polling query. The method also comprises determining a post-vote action that is linked to the selected option. Further, the method comprises presenting the post-vote action that is linked to the selected option on the UI of the mobile electronic device of the user.

In another aspect, the invention provides a method for providing tailored post-vote actions. The method comprises receiving, on the mobile electronic device of the user, a selection of an option associated with a polling query. The method also comprises determining a post-vote action that is linked to the selected option. Additionally, the method comprises presenting the post-vote action that is linked to the selected option on the user interface (UI) of the mobile electronic device of the user.

In a further aspect, the invention provides a method for providing polls having linked post-vote actions. The method comprises receiving a location associated with a mobile electronic device of a user. The method also comprises presenting, on a user interface (UI) of the mobile electronic device of the user, a polling query having two or more options, wherein each option presented is linked to a post-vote action. Additionally, the method comprises receiving, on the mobile electronic device of the user, a selection of an option from the two or more options in the polling query. The method further comprises determining a post-vote action that is linked to the selected option, wherein the post-vote action is determined based on the received location associated with the mobile electronic device of the user. Additionally, the method comprises presenting the post-vote action that is linked to the selected option on the UI of the mobile electronic device of the user.

In some embodiments, the post-vote action is selected from the group consisting of (1) read more, (2) purchase, (3) clip coupon, (4) watch video, (5) click through to website, and (6) lead generation. In some embodiments, the read more post-vote action comprises a presentation of one or more supplementary content. In some embodiments, the read more post-vote action comprises a presentation of one or more supplementary reading content. In some embodiments, the read more post-vote action comprises a presentation of one or more links to supplementary content. In some embodiments, the read more post-vote action comprises a presentation of one or more content selected from the group consisting of an article or a video.

In some embodiments, the purchase post-vote action comprises an offer to purchase an item. In some embodiments, the item is associated with the selected option. In some embodiments, the purchase to offer is a direct offer presented on the user interface. In some embodiments, the purchase to offer is a link to an offer to purchase the item.

In some embodiments, the clip coupon post-vote action comprises a coupon. In some embodiments, the coupon is a direct coupon presented on the user interface. In some embodiments, the coupon is a link to the coupon presented on the user interface. In some embodiments, the coupon is an electronic coupon presented on the user interface.

In some embodiments, the watch video post-vote action comprises a video. In some embodiments, the video is a direct video presented on the user interface. In some embodiments, the video is a link to the video presented on the user interface.

In some embodiments, the click through to website post-vote action comprises a website. In some embodiments, the website is a direct website presented on the user interface. In some embodiments, the website is a link to a website presented on the user interface.

In some embodiments, the lead generation post-vote action comprises an input box presented on the user interface. In some embodiments, the input box may be used to request a user's e-mail address.

In some embodiments, at least one of the two or more options is a photo image. In some embodiments, the two or more options are photo images. In some embodiments, at least one of the two or more options is a text. In some embodiments, the two or more options are text. In some embodiments, the two or more options include photo images and text.

In some embodiments, said polling query that is presented to the user is based on a location of a user. In some embodiments, the location of the user is determined based on the location of the mobile electronic device of the user. In some embodiments, the location of the user is determined based on a location input by the user.

In some embodiments, the retrieved location associated with a mobile electronic device of a user is determined based on the determined location of the mobile electronic device of the user. In some embodiments, the retrieved location associated with a mobile electronic device of a user is determined based on input received at the mobile electronic device of the user.

In some embodiments, methods further comprise presenting results of the polling query. In some embodiments, the results of the polling query are presented prior to presenting a post-vote action. In some embodiments, the results of the polling query are presented after presenting a post-vote action. In some embodiments, the results of the polling query are presented simultaneous to presenting a post-vote action. In some embodiments, the results of the polling query are presented independently of presenting a post-vote action. In some embodiments, the post-vote action is presented on the user interface of the mobile electronic device of the user.

In some embodiments, a method is a computer-implemented method. In particular, in some embodiments, methods described herein may be computer-implemented methods. Additional aspects of the invention provide computer readable medium comprising code that, when executed by one or more computer processors, implements a method of any of the methods described herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 illustrates an exemplary polling ad unit query, in accordance with embodiments;

FIG. 2 illustrates an exemplary post-vote action of reading more, in accordance with embodiments;

FIG. 3 illustrates an exemplary post-vote action of purchasing, in accordance with embodiments;

FIG. 4 illustrates an exemplary post-vote action of using a coupon, in accordance with embodiments;

FIG. 5 illustrates an exemplary post-vote action of watching a video, in accordance with embodiments;

FIG. 6 illustrates an exemplary post-vote action of lead generation, in accordance with embodiments;

FIG. 7 illustrates two screen shots of a polling ad unit having a post-vote action of using a coupon, in accordance with embodiments;

FIG. 8 illustrates two screen shots of a polling ad unit having a post-vote action of purchasing an item, in accordance with embodiments;

FIG. 9 illustrates two screen shots of a polling ad unit having a post-vote action of lead generation, in accordance with embodiments;

FIG. 10 illustrates another two screen shots of a polling ad unit having a post-vote action of lead generation, in accordance with embodiments;

FIGS. 11A and 11B illustrate two screen shots of a polling ad unit having a post-vote action of lead generation in context of a webpage, in accordance with embodiments;

FIG. 12 illustrates two screen shots of a polling ad unit having a post-vote action of a read more with percentage indicators, in accordance with embodiments;

FIG. 13 illustrates two screen shots of a polling ad unit having a post-vote action of a music video with percentage indicators, in accordance with embodiments;

FIG. 14 illustrates two screen shots of a polling ad unit having a post-vote action of a purchase with percentage indicators, in accordance with embodiments;

FIG. 15 illustrates two screen shots of a polling ad unit having a post-vote action of a coupon with percentage indicators, in accordance with embodiments;

FIG. 16 illustrates two screen shots of a polling ad unit having a post-vote action of an application download with percentage indicators, in accordance with embodiments;

FIG. 17 illustrates two screen shots of a polling ad unit having a post-vote action of a product launch with percentage indicators, in accordance with embodiments;

FIG. 18 illustrates two screen shots of a polling ad unit having a post-vote action of a contest with percentage indicators, in accordance with embodiments;

FIG. 19 illustrates a flowchart for creating a polling ad unit, in accordance with embodiments;

FIG. 20 illustrates a flowchart of a user interacting with a polling ad unit, in accordance with embodiments;

FIG. 21 illustrates a flowchart of types of post-vote actions in polling ad units, in accordance with embodiments;

FIG. 22 shows a computer system that is programmed or otherwise configured to facilitate a polling ad unit and the exchange of queries and responses to the queries between users and the polling ad unit, in accordance with embodiments;

FIG. 23 illustrates two screen shots of a polling ad unit having a post-vote action of a brand-focused purchase with percentage indicators, in accordance with embodiments; and

FIG. 24 illustrates two screen shots of a polling ad unit having a post-vote action of a brand-focused purchase that overtakes the screen of the user, in accordance with embodiments.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “chat,” as used herein, generally refers to a dialogue between a user and one or more other users. A chat can be between the user and another user, or between the user and multiple other users, such as a group chat. A chat can be facilitated by a computer system and implemented, for example, by way of mobile (or portable) electronic devices, such as mobile telephones, smart phones, tablet or slate personal computers (PC's), or laptop PC's.

The term “rating,” as used herein, generally refers to a position in a scale of status, or the action or process of giving a specified rank or place within a grading system.

The term “polling,” as used herein, generally refers to the process of voting or casting a selection of an item among multiple items. In some examples, the term “polling” may not refer to “Yes” and “No” responses.

The term “query,” as used herein, generally refers to a request for a response from a user. A query can include a question. A query can include a polling request or survey request.

### Methods for Presenting Queries

An aspect of the present disclosure provides methods for presenting polling ad units, that includes one or more queries, to users and receiving responses to the queries. The queries can be polling, surveying, or rating. These methods can be implemented using computer systems of the present disclosure, as described elsewhere herein. In some examples, polling ad units may be presented on a mobile-only ad network. In additional examples, polling ad units may be embedded with post-vote actions across other properties, such as mobile applications and/or websites.

A method for providing a polling ad unit, that includes one or more queries and one or more post-vote actions, and receiving a response to a query and/or post-vote action comprises receiving a query of a polling ad unit from an advertiser or publisher. The query can be received on a server or an electronic device of a user, such as a mobile (or portable) electronic device. Next, the query can be presented on a user interface (UI) of a web-based application or mobile application on the electronic device of the user. The query can be a polling query, survey query, or rating query. Next, a response to the query, or “vote,” is received by the advertiser or publisher from the user and presented on the UI. The response may be presented with a post-vote action that may be linked to the received response. In particular, the post-vote action may couple additional information associated with the response to the query.

The response can be transmitted from the electronic device of the user to the advertiser and/or publisher directly or through another computer system, such as a computer server. In some examples, the computer server is the intermediary between the electronic device of the user and the advertiser.

The UI can be a graphical user interface (GUI) or a web-based user interface. The GUI can include textual and/or graphical information for enabling a user to view the polling ad unit and respond to the post-vote action.

In some cases, the polling ad unit is displayed in a mobile application. The mobile application can display a query from the polling ad unit. Additionally, the mobile application can display queries, responses, and post-vote actions associated with the polling ad unit. In some cases, the polling ad unit is displayed in a web-based application. The web-based application can display a query from the polling ad unit. Additionally, the web-based application can display queries, responses, and post-vote actions associated with the polling ad unit.

The response to the query of the polling ad unit can be displayed on a user interface of a web-based application or mobile application executed on the electronic device of the user. The web-based application or mobile application can also be configured to display a post-vote action that is associated with the selected response. The post-vote action may be limited to the selected response. In particular, each response to a query may be linked to a post-vote action. These linked responses and post-vote actions may be “polling pairs” such that a post-vote action is related to the content of the query response. Additionally, if a query has three responses, the query may be linked to three discrete post-vote actions.

In some examples, the polling ad unit can be received by the user in the form of an electronic message. In some cases, the electronic message is a short message service (SMS) text message or a multimedia messaging service (MMS) text message. As an alternative, the electronic message is an electronic mail (email) or an instant message.

In some examples, a polling query having two or more options may be presented on a user interface (UI) of a mobile electronic device of a user. Each option presented may be linked to a post-vote action. Additionally, a selection of an option from the two or more options in the polling query may be received on the mobile electronic device of the user. A post-vote action that is linked to the selected option may be determined. Further, the post-vote action that is linked to the selected option may be presented on the UI of the mobile electronic device of the user.

### User Interfaces for Presenting Polling Ad Units

The present disclosure provides user interfaces for facilitating the display of polling ad units. Such user interfaces can be implemented using computer systems of the present disclosure, as describe elsewhere herein. User interfaces provided herein can be displayed on electronic displays of electronic devices of users (e.g., mobile electronic devices), which can include passive displays or active displays. Examples of displays include monitors and touchscreens, which can permit user interaction using one or more fingers of the user.

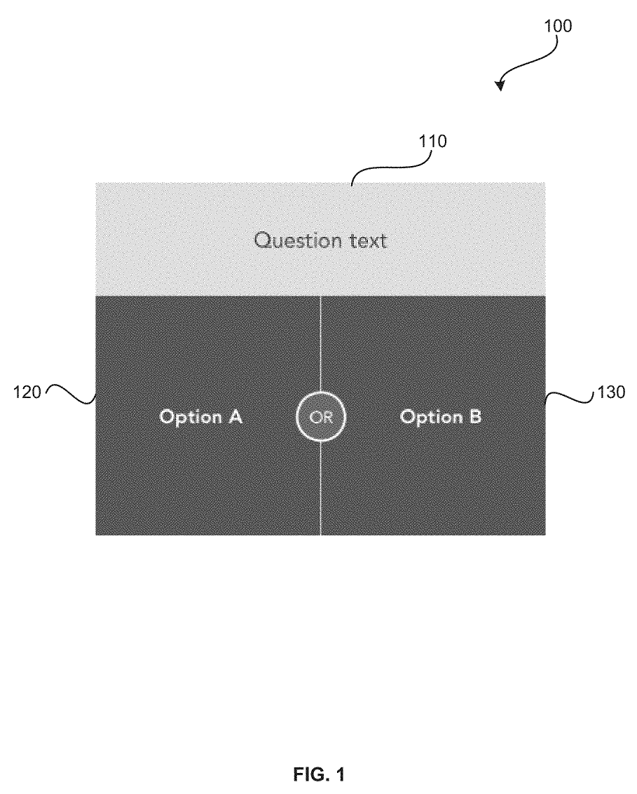

FIG. 1 illustrates an exemplary polling ad unit query 100, in accordance with embodiments. As seen in FIG. 1, a polling ad unit query 100 comprises a question text 110, a first option 120, and a second option 130. Each option 120, 130 may be linked to a post-vote action, as described below. The polling ad unit query 100 may be presented to a user from an advertiser or publisher. In particular, once the user selects an option, the user may be presented with a post-vote action that is linked to the selected option.

In some examples, an advertiser or publisher can set a geographic location (“geolocation”) in which a user may respond to a polling ad unit. For example, the advertiser or publisher can elect to have users that are in Manhattan, N.Y. or San Francisco, Calif. respond to the polling ad unit. In such a case, users in other geolocations may not be able to respond to the polling ad unit. In some examples, the geolocation of a given user can be determined using an electronic device of the user, such as using a global positioning system (GPS) or wireless triangulation. In some examples, the geolocation of a given user can be input by a user. For example, a user may input a geolocation in the user's mobile electronic device. In some examples, a polling ad unit my query a user for the user's geolocation, in response to which a user may input a particular geolocation. The geolocation input by the user may or may not coincide with the user's present geolocation. For example, if a user primarily resides in Los Angeles but is on a trip to New York City when interacting with the polling query, the user may choose to input a geolocation of Los Angeles so as to return post-vote actions that are of interest to the user's place of residence.

In additional examples, the polling ad unit can be rendered to be visually distinct than other text and/or images presented on a user interface, which can help solicit user response(s) to the polling ad unit. For example, the polling ad unit can have a background that is darker or lighter than other windows in the user interface, or a shape that is different than other windows presented in the user interface. In other examples, the polling ad unit can be rendered to be animatable. In some examples, polling ad units may be presented as a fixed size. The fixed size of the polling ad unit may be a full-screen size displayed on a mobile device. The fixed size of the polling ad unit may be a portion of a full-screen size displayed on a mobile device. In some examples, a polling ad unit may switch between a first screen shot and a second screen shot by flipping from the first screen shot to the second screen shot. In examples, the first screen shot and the second screen shot may both be of a same, fixed size.

The polling ad unit can include graphical and/or textual information, which can be geared towards soliciting user response(s). In some cases, the polling ad unit can display user responses in real time or, in some cases, after a given period of time. For example, if the polling ad unit has a rating query or polling query, then the polling ad unit can display responses to the rating or polling query in real time or after at 1, 2, 3, 4, 5 or more minutes. In additional examples, the polling ad unit can post a query and provide details as to which advertiser or publisher posted the query, and also provide additional details as to the query.

Windows for presenting polling ad units may be dynamic or static. Such windows may be continuously, semi-continuously, or periodically updated. For instance, windows for presenting polling ad units can be changed or updated based on responses received from queries of the polling ad units. For example, a poll query can be updated in real time to reflect responses to the poll. As an alternative, windows for presenting queries of polling ad units can be updated after a given period of time, such as, for example, after a period that is greater than or equal to about 10 seconds, 30 seconds, 1 minute, 5 minutes, 10 minutes, 20 minutes, 30 minutes, or 1 hour. For example, a window with a poll query can present the results of the poll after a period of 5 minutes.

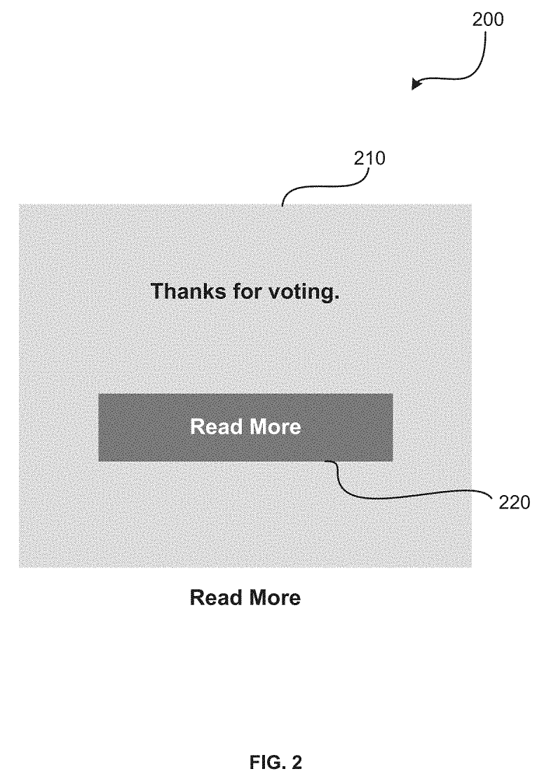

FIGS. 2-6 illustrate exemplary screenshots of post-vote actions that may be linked to a selected option from the polling ad unit query 100. In particular, FIGS. 2-6 illustrate post-vote actions of reading more, purchasing, using a coupon, watching a video, and lead generation. Additional post-vote actions may include downloading material, such as downloading a mobile application; an action to enter a contest; or an action to follow an advertiser on a social media platform. Examples of social media platforms may include Facebook, Twitter, or Instagram.

In some examples, a particular post-vote action that is provided to a user may be based on the user's previous browser history. In some examples, the post-vote action may be based on a user's previous browser history within a predetermined amount of time, such as the previous hour, previous two hours, previous day, previous week, or more than the previous week.

FIG. 2 illustrates a screenshot 200 of an exemplary post-vote action of reading more, in accordance with embodiments. In particular, FIG. 2 provides a screenshot 200 that includes an example of a message 210 associated with selecting a response. The message 210 may include the selected response (not shown) or may comprise another message. As seen in FIG. 2, message 210 says, “Thanks for voting” so as to indicate to the user that the response has been received. Additionally, screenshot 200 shows a post-vote action 220 that allows a user to read more about a topic associated with the selected response. In examples, the link provided to post-vote action 220 may include additional resources that are associated with the selected responses. In some examples, selecting a “read more” post-vote action may lead a user to supplementary material, such as an article or video or other type of content that may be related to the polling ad unit.

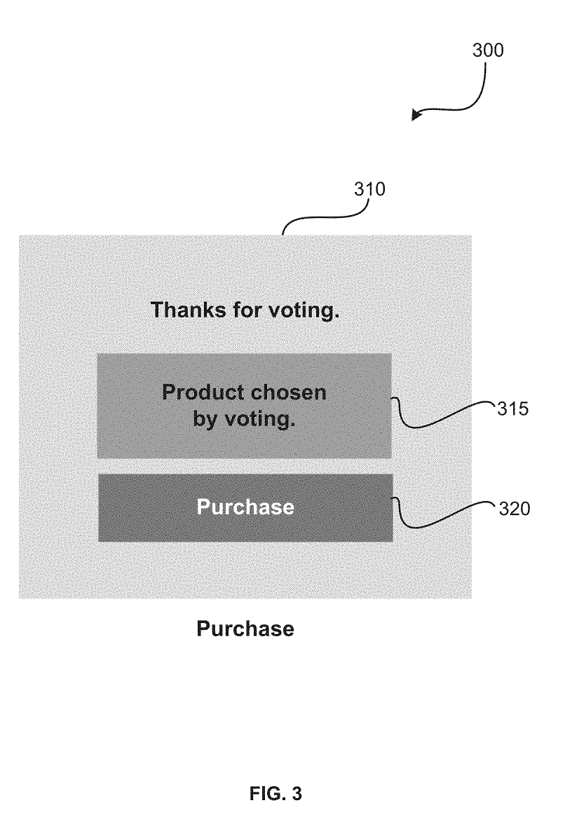

FIG. 3 illustrates a screenshot 300 of an exemplary post-vote action of purchasing, in accordance with embodiments. In particular, FIG. 3 provides a screenshot 300 that includes an example of a message 310 associated with selecting a response. The message 310 may include the selected response and/or may comprise another message. As seen in FIG. 3, message 310 says, “Thanks for voting” so as to indicate to the user that the response has been received. Additionally, message 310 includes a photo 315 of a product chosen by voting. Screenshot 300 also shows a post-vote action 320 that allows a user to purchase a product associated with the selected response. In examples, the link provided to post-vote action 320 may include one or more purchase options for the product.

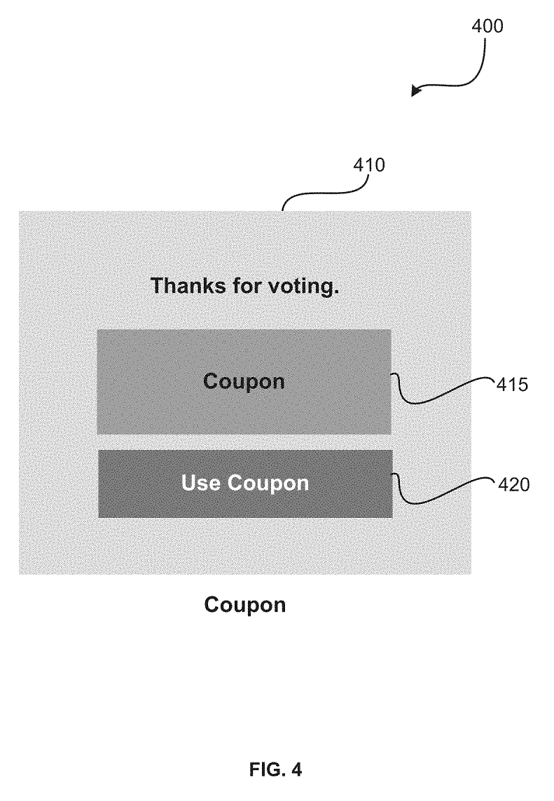

FIG. 4 illustrates a screenshot 400 of an exemplary post-vote action of using a coupon, in accordance with embodiments. In particular, FIG. 4 provides a screenshot 400 that includes an example of a message 410 associated with selecting a response. The message 410 may include the selected response (not shown) or may comprise another message. As seen in FIG. 4, message 410 says, “Thanks for voting” so as to indicate to the user that the response has been received. Additionally, message 410 includes an image 415 of a coupon that may be associated with the selected response. Screenshot 400 also shows a post-vote action 420 that allows a user to use the coupon associated with the selected response. In examples, the link provided to post-vote action 420 may include additional resources that are associated with the coupon, such as locations of retailers where the coupon may be purchased and/or a link to use the coupon directly.

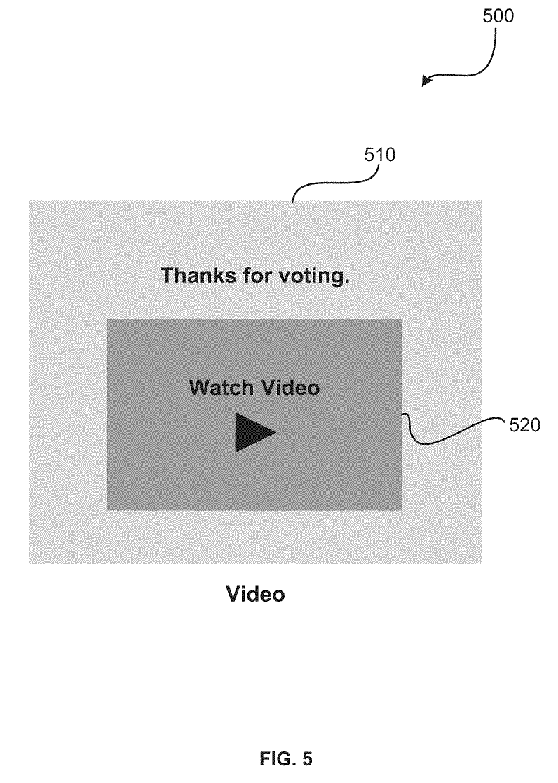

FIG. 5 illustrates a screenshot 500 of an exemplary post-vote action of watching a video, in accordance with embodiments. In particular, FIG. 5 provides a screenshot 500 that includes an example of a message 510 associated with selecting a response. The message 510 may include the selected response (not shown) or may comprise another message. As seen in FIG. 5, message 510 says, “Thanks for voting” so as to indicate to the user that the response has been received. Additionally, screenshot 500 shows a post-vote action 520 that allows a user to watch a video about a topic associated with the selected response. In examples, the link provided to post-vote action 520 may include additional resources that are associated with the selected responses.

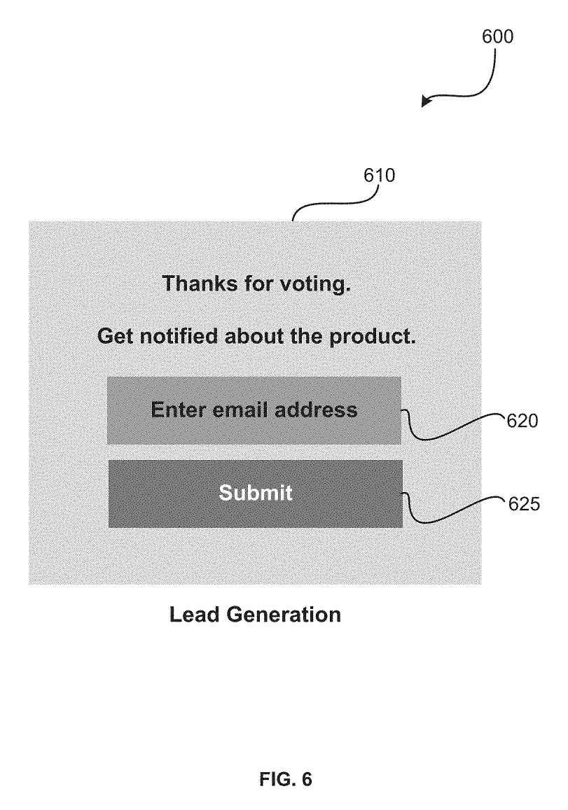

FIG. 6 illustrates a screenshot 600 of an exemplary post-vote action of lead generation, in accordance with embodiments. In particular, FIG. 6 provides a screenshot 600 that includes an example of a message 610 associated with selecting a response. The message 610 may include the selected response (not shown) or may comprise another message. As seen in FIG. 6, message 610 says, “Thanks for voting” so as to indicate to the user that the response has been received. Message 610 also says “Get notified about the product” and provides a post-vote action 620 that allows a user to enter an e-mail address to learn more about a topic associated with the selected response. In examples, the link provided to post-vote action 620 may be used to add the user's information, such as an e-mail address or phone number, to mailing lists associated with the selected response. In additional examples, lead generation may be used by advertisers to provide interactive content, such as entering a contest. In some examples, lead generation may be used by advertisers to give users an opportunity to be notified when a product, service, and/or event launches. The screenshot 600 also has a submit 625 button to confirm the use of the user's e-mail address.

Additional aspects of polling ad units for advertisers may be discussed. In particular, polling ad units may be an actionable and engaging form of a polling ad unit that is displayed as a poll with post-vote actions.

Some benefits of polling ad units for advertisers include risk-free advertising; flexible budgets; measurable return on investment; reaching targeted people at targeted times; and post-vote actions. Polling ad units may be a risk-free form of advertising because an advertiser may only be asked to pay when a user engages with a query associated with the polling ad unit. Additionally, polling ad units may be used with flexible budgets. In particular, advertisers may set their own budgets and/or bid for each ad based on your advertising goals. Polling ad units may also have a measurable return on investment, in particular, data such as how many people view your poll, what percentage engage with them, and how many complete post vote action. In further examples, polling ad units may be used to reach targeted people at targeted times. In particular, polling ad units may be contextually relevant that may only be shown to a target audience. In additional examples, post-vote actions may include reading more material, such as directing people to a website for traffic; purchasing items, such as directing people to purchase the product they said they liked better; clipping coupon, so as to increase immediate sales; watching videos, so as to show a video to people who have demonstrated interest; and lead generation, such as collecting highest quality leads, such as of people who have demonstrated interest by voting.

Advertisers may use a process to create polling ad units. In particular, at a first step, an advertiser may create a poll. At a second step, the advertiser may create optional post-vote actions. At a third step, the advertiser may set a bid/maximum budget per engagement with a user. At a fourth step, the advertiser may facilitate people to see an advertisement on a mobile application and/or on a syndication network. At a fifth step, results may be obtained from polls for market research. Additionally, polling ad units may be used to obtain customers, traffic, and leads from post-vote actions.

Additional aspects of polling ad units for publishers may be discussed. In particular, polling ad units may be used to generate revenue by placing a polling ad unit on a particular website or mobile application.

Some benefits that may come from publishers placing polling ad units on their webpages and/or mobile applications include targeted ads; full control; and real-time bidding. In some examples, targeted advertisements may be used. In particular, ads may be reviewed to ensure they're high quality and relevant to a publisher's content and/or audience. In additional examples of benefits, publishers may have full control of the polling ad units. In particular, publishers may block advertisements that they don't want to show, and/or may customize where and when advertisements appear on a particular website or mobile application. Further, publishers may benefit from real-time bidding. In examples, only the highest paying advertisements may get displayed. In particular, advertisers may be for a publisher's advertising space so that the publisher may get the most revenue for their webpage and/or mobile application real estate.

Publishers may use a process to publish polling ad units. At a first step, a publisher may select an ad unit size. At a second step, the publisher may choose where they want advertisements to be displayed. At a third step, the publisher may monitor as a highest paying, relevant ad goes live to their publishing audience, and at a fourth step the publisher may collect revenue.

### EXAMPLES

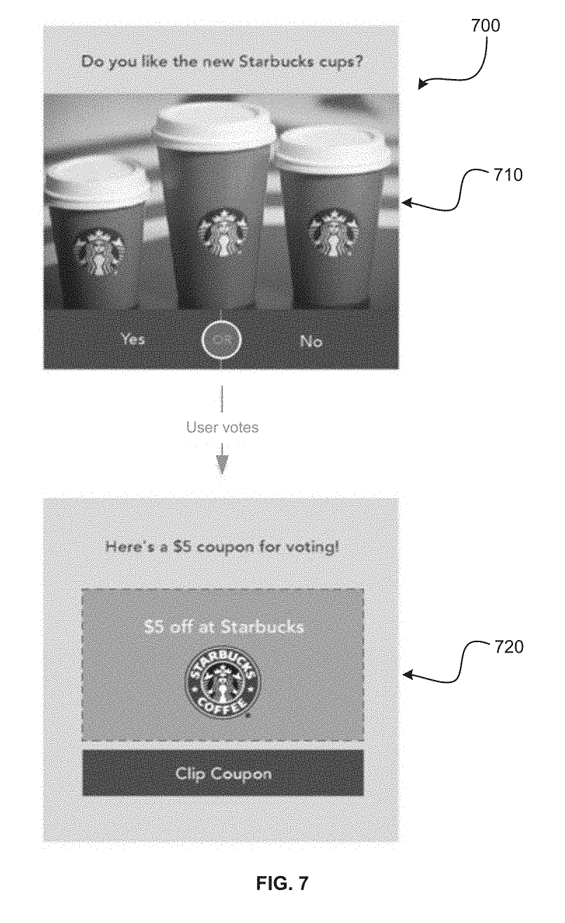

FIGS. 7-18 and FIGS. 23-24 schematically illustrate polling pairs of polling ad units that may be presented to a user. The polling ad units can be implemented using a computer system that has a computer processor that is programmed to execute the application, such as a mobile electronic device with an electronic display.

FIG. 7 illustrates two screen shots of a polling ad unit 700 having a post-vote action of using a coupon, in accordance with embodiments. In particular, FIG. 7 comprises screen shots 710, 720 of a polling pair of the polling ad unit 700. In particular screenshot 710 illustrates a query, “Do you like the new Starbucks cups?” The query has an image of the new Starbucks cups as well as a first and second option of “Yes” and “No,” respectively. Once a user selects an option, a post-vote action is displayed in screenshot 720. In particular, screenshot 720 illustrates a $5 coupon that may be used for Starbucks. Screenshot 720 also includes a button for clipping the coupon. In other examples, a user may use the coupon directly on a web-based Starbucks application. In some examples, a user may clip the coupon and use the coupon in-store at a Starbucks location.

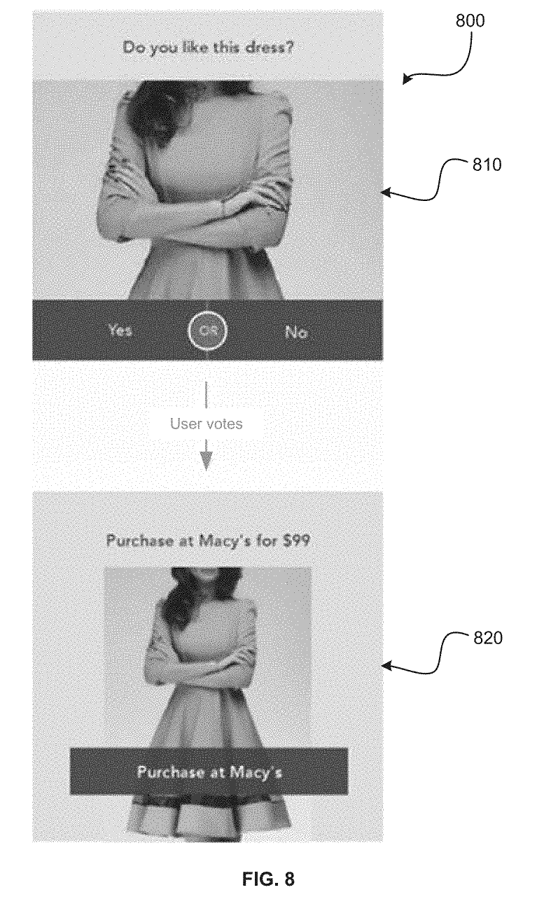

FIG. 8 illustrates two screen shots of a polling ad unit 800 having a post-vote action of purchasing an item, in accordance with embodiments. In particular, FIG. 8 comprises screen shots 810, 820 of a polling pair of the polling ad unit 800. In particular screenshot 810 illustrates a query, “Do you like this dress?” The query has an image of the dress as well as a first and second option of “Yes” and “No,” respectively. Once a user selects an option, a post-vote action is displayed in screenshot 820. In particular, screenshot 820 illustrates a message indicating the dress is available for purchase at Macy's for $99. The screen shot 820 also includes a link to purchase the dress. In particular, the link to buy the dress may provide a user to a webpage where the user may purchase the dress.

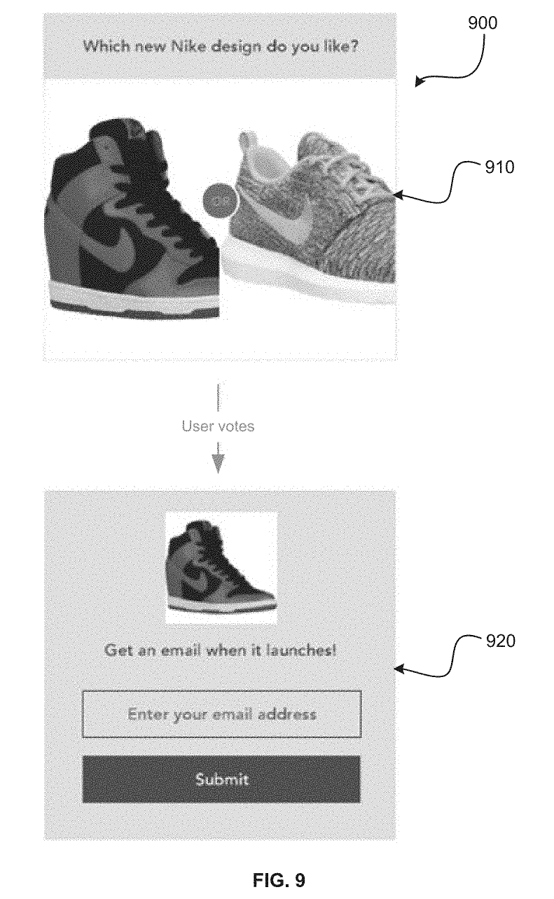

FIG. 9 illustrates two screen shots of a polling ad unit 900 having a post-vote action of lead generation, in accordance with embodiments. In particular, FIG. 9 comprises screen shots 910, 920 of a polling pair of the polling ad unit 900. In particular, screenshot 910 illustrates a query, “Which Nike design do you like?” The query has an image of two images of Nike shoes as a first and second option, respectively. Once a user selects an option, a post-vote action is displayed in screenshot 920. In particular, screenshot 920 illustrates an image of the selected shoe as well as an opportunity for the user to sign up for notification of the shoe's launch. Screenshot 920 also includes a button for confirming the user's e-mail address may be added to an e-mail list for launching the shoe.

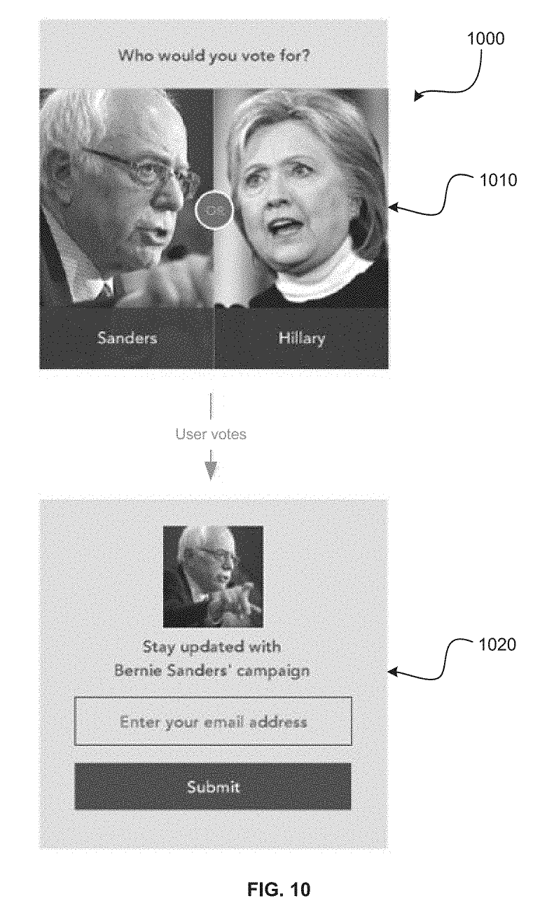

FIG. 10 illustrates another two screen shots of a polling ad unit 1000 having a post-vote action of lead generation, in accordance with embodiments. In particular, FIG. 10 comprises screen shots 1010, 1020 of a polling pair of the polling ad unit 1000. In particular screenshot 1010 illustrates a query, “Who would you vote for?” along with two options of Bernie Sanders and Hilary Clinton, respectively. of “Yes” and “No,” respectively. As seen in FIG. 10, polling options that are presented as options may include captions. In particular, FIG. 10 illustrates photo options of Bernie Sanders and Hillary Clinton with the captions of “Sanders” and “Hillary,” respectively. Once a user selects an option, a post-vote action is displayed in screenshot 1020. In particular, screenshot 1020 illustrates a campaign sign-up opportunity for the user to enter their e-mail so as to receive updates about their selected candidate. Screenshot 1020 also includes a button for confirming sharing their e-mail address with the chosen campaign.

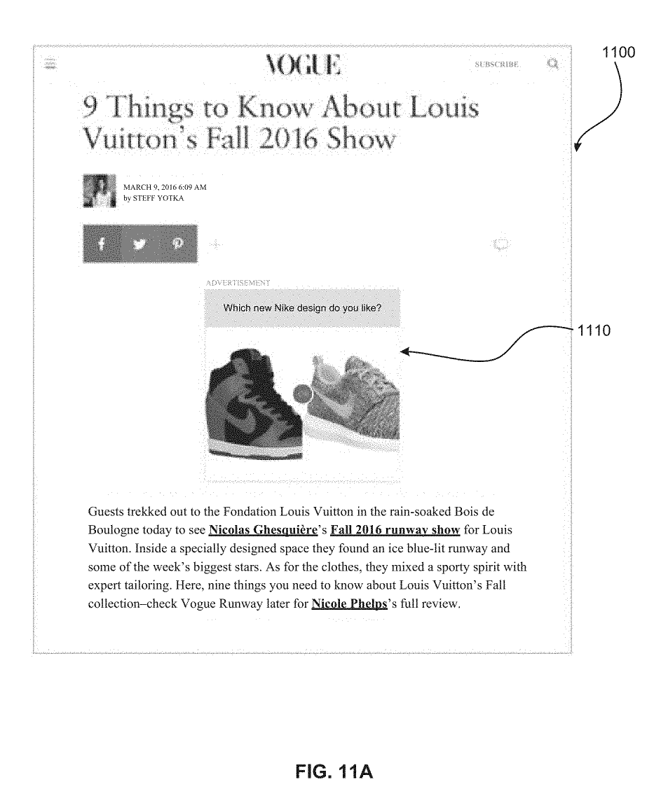

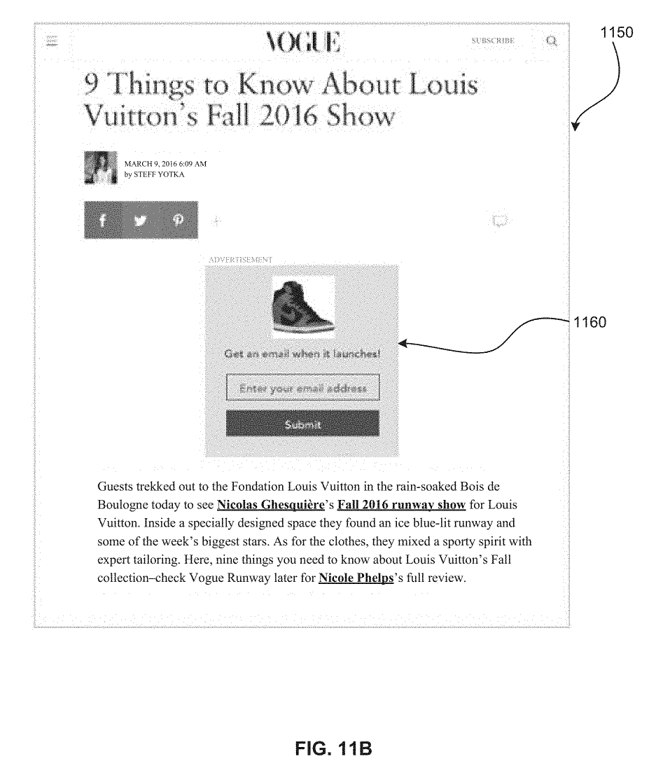

FIGS. 11A and 11B illustrate two screen shots 1100, 1150 of a polling ad unit having a post-vote action of lead generation in context of a webpage, in accordance with embodiments. In particular, screenshot 1100 illustrates a webpage that has a portion 1110 devoted to the polling ad unit that is illustrated in FIG. 9. In particular, the query states, “Which new Nike design do you like?” The query has images of two Nike shoes. Once a user selects an option, a post-vote action is displayed in a portion 1160 of screenshot 1150. In particular, portion 1160 illustrates the chosen Nike shoe along with an opportunity to join an e-mail list focused on the Nike advertisement campaign for the selected Nike shoe.

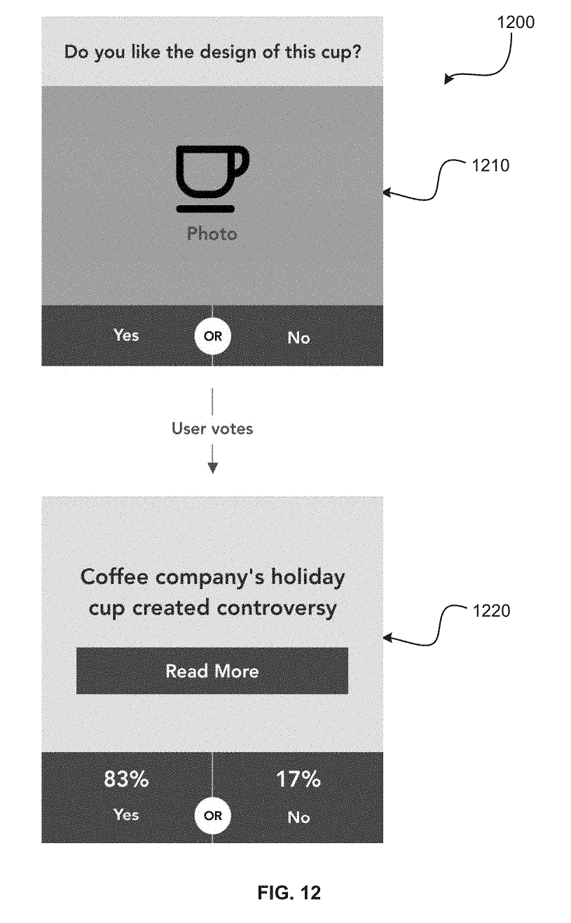

FIG. 12 illustrates two screen shots of a polling ad unit 1200 having a post-vote action of a read more with percentage indicators, in accordance with embodiments. In particular, FIG. 12 comprises screen shots 1210, 1220 of a polling pair of the polling ad unit 1200. In particular screenshot 1210 illustrates a query, “Do you like the design of this cup?” The query has a generalized image of a cup, as well as a first and second option of “Yes” and “No,” respectively. Once a user selects an option, a post-vote action is displayed in screenshot 1220. In particular, screenshot 1220 illustrates a read more indicator that may be used to read about a coffee company's holiday cup controversy. Additionally, percentage indicators are provided to illustrate to a user how many other users voted “Yes” or “No,” respectively.

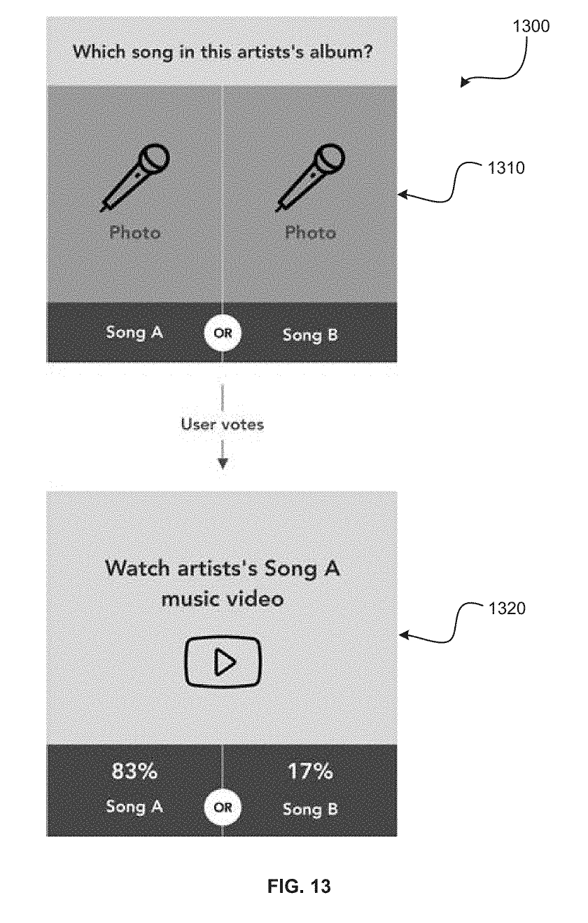

FIG. 13 illustrates two screen shots of a polling ad unit 1300 having a post-vote action of a music video with percentage indicators, in accordance with embodiments. In particular, FIG. 13 comprises screen shots 1310, 1320 of a polling pair of the polling ad unit 1300. In particular screenshot 1310 illustrates a query, “Which song is this artist's album?” The query has a generalized image of two microphones, as well as a first and second option of “Song A” and “Song B,” respectively. The generalized image may be of an artist, an album, or another image associated with a song, among other examples. Once a user selects an option, a post-vote action is displayed in screenshot 1320. In particular, screenshot 1320 illustrates a music video that a user may watch. Additionally, percentage indicators are provided to illustrate to a user how many other users voted “Song A” or “Song B,” respectively.

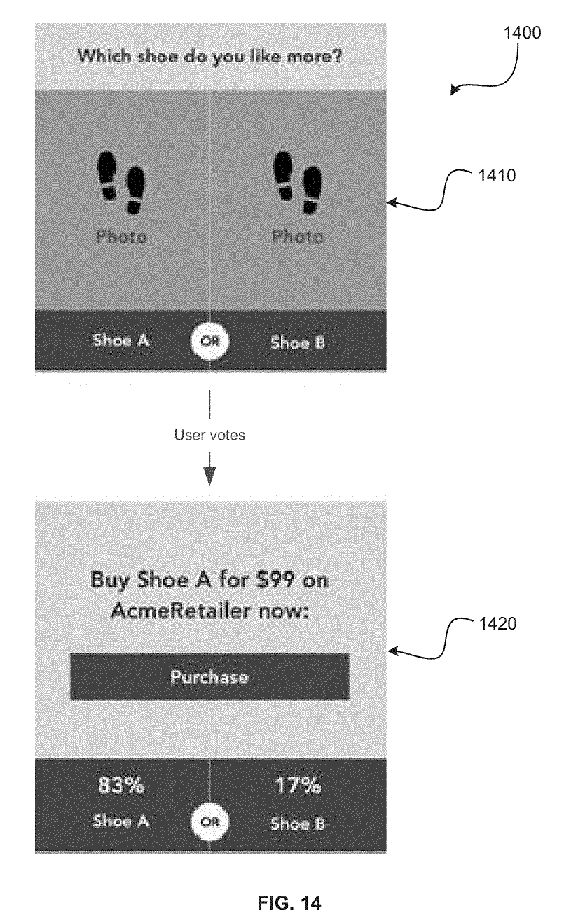

FIG. 14 illustrates two screen shots of a polling ad unit 1400 having a post-vote action of a purchase with percentage indicators, in accordance with embodiments. In particular, FIG. 14 comprises screen shots 1410, 1420 of a polling pair of the polling ad unit 1400. In particular screenshot 1410 illustrates a query, “Which shoe do you like more?” The query has a generalized image of two footprints, as well as a first and second option of “Shoe A” and “Shoe B,” respectively. The generalized image may be of a shoe. Examples of a shoe may include a running shoe, high-heeled shoe, or sandal. Once a user selects an option, a post-vote action is displayed in screenshot 1420. In particular, screenshot 1420 illustrates a purchase offer to buy a particular shoe, such as the selected shoe, for $99. Screenshot 1420 also includes a button for purchasing the shoe. Additionally, percentage indicators are provided to illustrate to a user how many other users voted “Shoe A” or “Shoe B,” respectively.

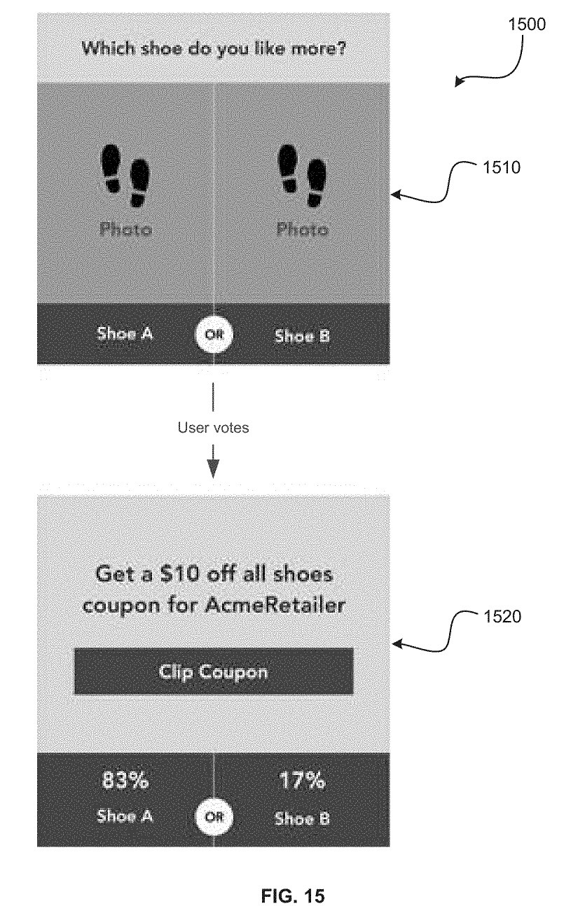

FIG. 15 illustrates two screen shots of a polling ad unit 1500 having a post-vote action of a coupon with percentage indicators, in accordance with embodiments. In particular, FIG. 15 comprises screen shots 1510, 1520 of a polling pair of the polling ad unit 1500. In particular screenshot 1510 illustrates a query, “Which shoe do you like more?” The query has a generalized image of two footprints, as well as a first and second option of “Shoe A” and “Shoe B,” respectively. The generalized image may be of a shoe. Examples of a shoe may include a running shoe, high-heeled shoe, or sandal. Once a user selects an option, a post-vote action is displayed in screenshot 1520. In particular, screenshot 1520 illustrates a $10 coupon that may be used for an Acme Retailer. Screenshot 1520 also includes a button for clipping the coupon. Additionally, percentage indicators are provided to illustrate to a user how many other users voted “Shoe A” or “Shoe B,” respectively.

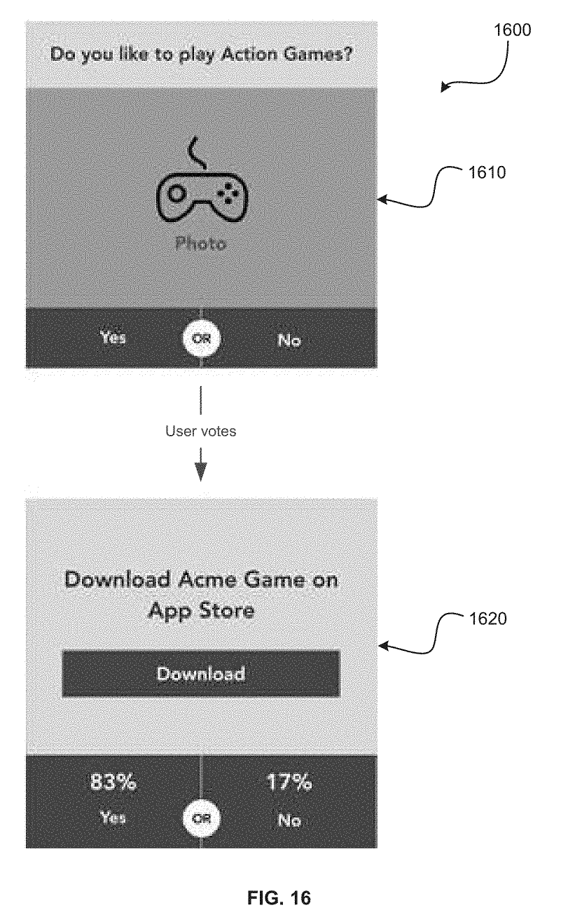

FIG. 16 illustrates two screen shots of a polling ad unit 1600 having a post-vote action of an application download with percentage indicators, in accordance with embodiments. In particular, FIG. 16 comprises screen shots 1610, 1620 of a polling pair of the polling ad unit 1600. In particular screenshot 1610 illustrates a query, “Do you like to play Action Games?” The query has a generalized image of a game console, as well as a first and second option of “Yes” and “No,” respectively. The generalized image may be of a game logo, a game company logo, or another image associated with a video game. Once a user selects an option, a post-vote action is displayed in screenshot 1620. In particular, screenshot 1620 illustrates an option to download an Acme Game at an App store, as well as a button to download the game. In additional examples, a user may choose from more than one game presented on a screenshot such as screenshot 1620. Additionally, percentage indicators are provided to illustrate to a user how many other users voted “Yes” or “No,” respectively.

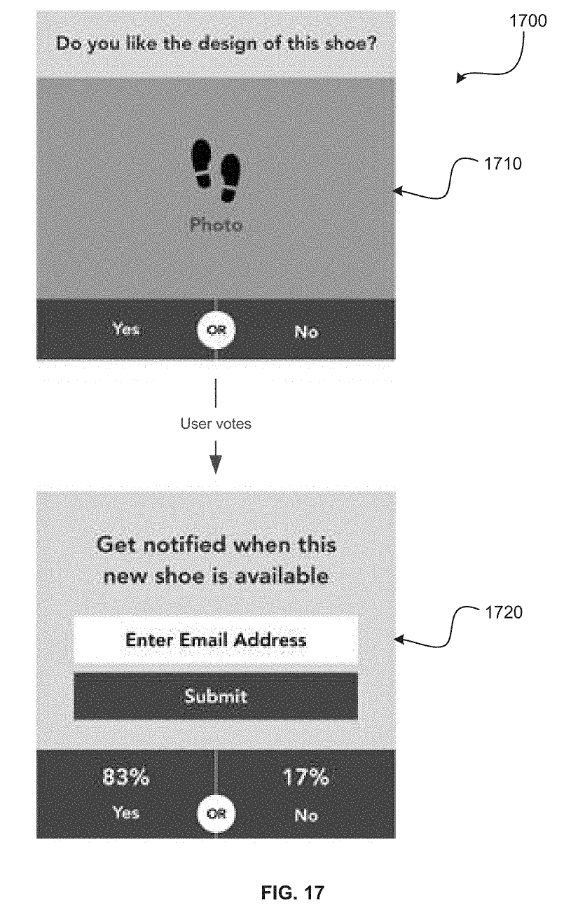

FIG. 17 illustrates two screen shots of a polling ad unit 1700 having a post-vote action of a product launch with percentage indicators, in accordance with embodiments. In particular, FIG. 17 comprises screen shots 1710, 1720 of a polling pair of the polling ad unit 1700. In particular screenshot 1710 illustrates a query, “Do you like the design of this shoe?” The query has a generalized image of feet, as well as a first and second option of “Yes” and “No,” respectively. The generalized image may be of a shoe. Examples of a shoe may include a running shoe, high-heeled shoe, or sandal. Once a user selects an option, a post-vote action is displayed in screenshot 1720. In particular, screenshot 1720 illustrates a product launch that indicates when a new shoe may be available. Screenshot 1720 also includes an entry form to add an e-mail address and a submit button. Additionally, percentage indicators are provided to illustrate to a user how many other users voted “Yes” or “No,” respectively.

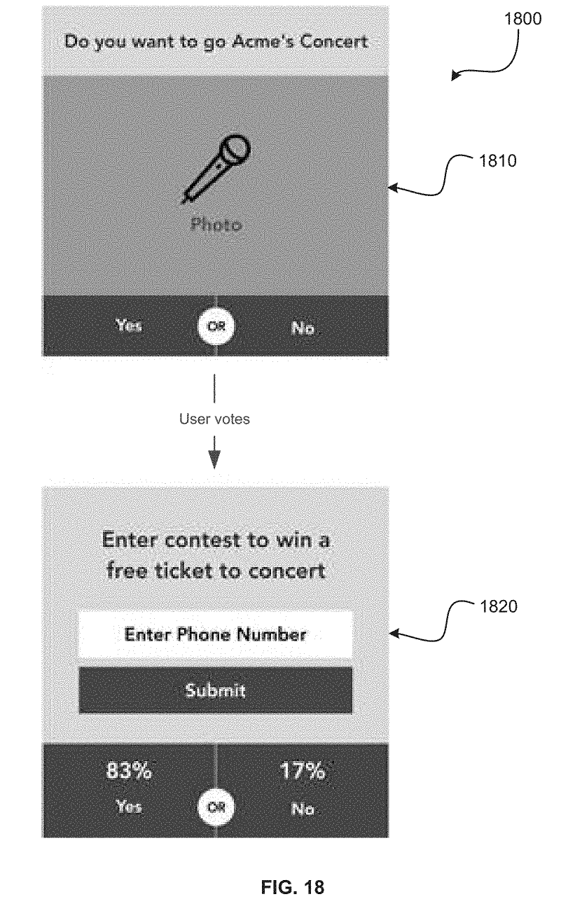

FIG. 18 illustrates two screen shots of a polling ad unit 1800 having a post-vote action of a contest with percentage indicators, in accordance with embodiments. In particular, FIG. 18 comprises screen shots 1810, 1820 of a polling pair of the polling ad unit 1800. In particular screenshot 1810 illustrates a query, “Do you want to go to Acme's Concert?” The query has a generalized image of a microphone, as well as a first and second option of “Yes” and “No,” respectively. The generalized image may be replaced with other images associated with a concert, such as an image of a band or a concert venue. Once a user selects an option, a post-vote action is displayed in screenshot 1820. In particular, screenshot 1820 illustrates a contest to enter to win a free ticket to a concert. Screenshot 1820 also includes an entry form to add a phone number and a submit button. Additionally, percentage indicators are provided to illustrate to a user how many other users voted “Yes” or “No,” respectively.

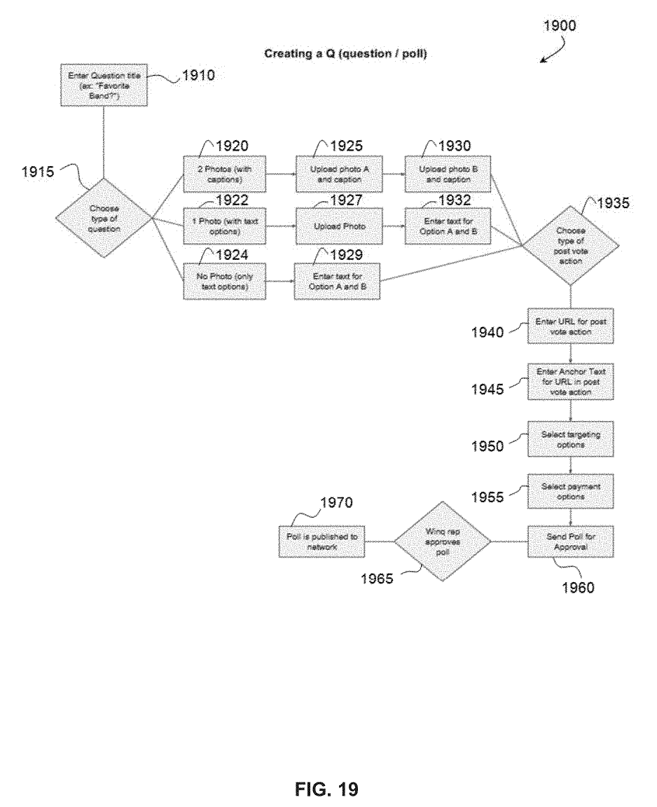

FIG. 19 illustrates a flowchart 1900 for creating a polling ad unit, in accordance with embodiments. At block 1910, a question title is entered. In an example, a question title may state, “What is your favorite band?” At block 1915, a type of question may be chosen. The type of question may include two photos 1920, may include one photo 1922, or may include no photo 1924. Additionally, the different selection of photo choices may include captions and/or text options.

In an example when two photos are provided, a first photo may be uploaded at block 1925. The first photo may be uploaded with or without captions. At block 1930 a second photo may be uploaded. The second photo may be uploaded with or without captions. In examples where one photo is provided, at block 1927 a photo may be uploaded. At block 1932, text may be uploaded for options A or B. A user may select from options A or B when responding to a polling query. In examples where no photo is uploaded, text options may be provided. At block 1929, text may be provided for options A and B.

Once the polling query has been established based on the options above, a type of post-vote action may be chosen at block 1935. Post-vote actions may include actions as described above. At block 1940, a URL may be entered for a post-vote action. At block 1945, anchor text for a URL in a post-vote action may be entered. At block 1950, targeting options may be selected. At block 1955, payment options may be selected. At block 1960, a poll may be sent for approval. At block 1965, a representative may approve or deny a poll. When a poll is approved, at block 1970 the poll may be published to a network.

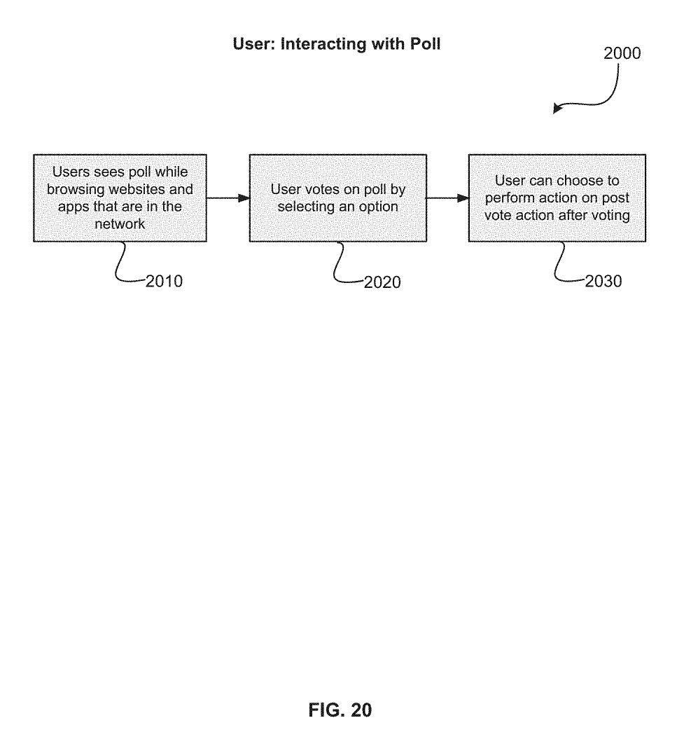

FIG. 20 illustrates a flowchart 2000 of a user interacting with a polling ad unit, in accordance with embodiments. At block 2010, a user sees a poll while browsing websites and applications that are in the network. At block 2020, a user votes on a poll by selecting an option. At block 2030, a user can choose to perform an action on post-vote action after voting. In particular, the user can choose to perform an action on post-vote action after voting on the poll.

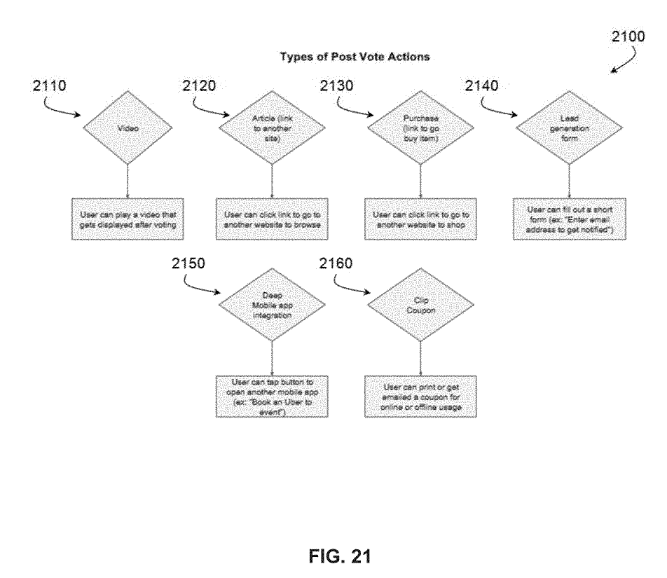

FIG. 21 illustrates a flowchart 2100 of types of post-vote actions in polling ad units, in accordance with embodiments. In particular, FIG. 21 illustrates post-vote actions associated with a video; article; purchase; lead generation form; deep mobile application integration; and coupons. As seen in flow 2110, a video may be presented in a post-vote action. In particular, a user may play a video that gets displayed after voting. As seen in flow 2120, an article may be presented in a post-vote action. In particular, a user may click a link to go to another website to browse an article and/or a link to another site. As seen in flow 2130, a purchase may be presented in a post-vote action. In particular, a user may click a link to go to another website to shop. As seen in flow 2140, a lead generation form may be presented in a post-vote action. In particular, a user may fill out a short form (e.g., “Enter e-mail address to get notified”). As seen in flow 2150, a deep mobile application integration may be provided in a post-vote action. In particular, a user may tap button to open an anchor mobile application (e.g., “Book an Uber to event”). As seen in flow 2160, coupons may be provided in a post-vote action. In particular, a user may print or receive an e-mail for a coupon for online or offline usage.

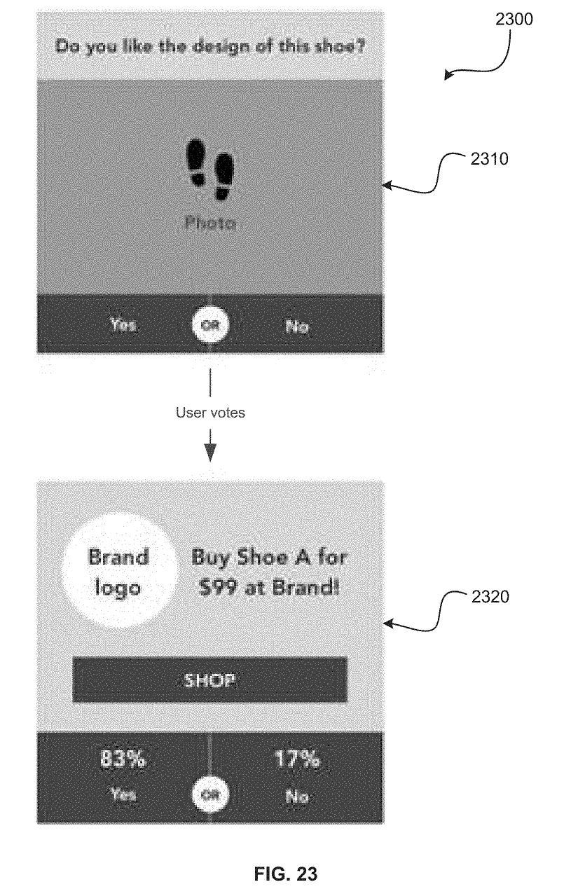

FIG. 23 illustrates two screen shots of a polling ad unit having a post-vote action of a brand-focused purchase with percentage indicators, in accordance with embodiments. In particular, FIG. 23 comprises screen shots 2310, 2320 of a polling pair of the polling ad unit 2300. In particular screenshot 2310 illustrates a query, “Do you like the design of this shoe?” The query has a generalized image of a shoe, as well as a first and second option of “Yes” and “No,” respectively. The generalized image may be replaced with other images associated with a shoe. Once a user selects an option, a post-vote action is displayed in screenshot 2320. In particular, screenshot 2320 illustrates a brand-focused purchase opportunity, as well as an opportunity to shop for the particular brand-focused purchase. As seen in screenshot 2320, a purchase opportunity is provided for a particular “Shoe A” at a particular price “$99.” Additionally, the “Shop” option provided may link through to a website that sells the particular advertised product (e.g., “Shoe A”) for the particular advertised price (e.g., “$99”). Additionally, percentage indicators are provided to illustrate to a user how many other users voted “Yes” or “No,” respectively.

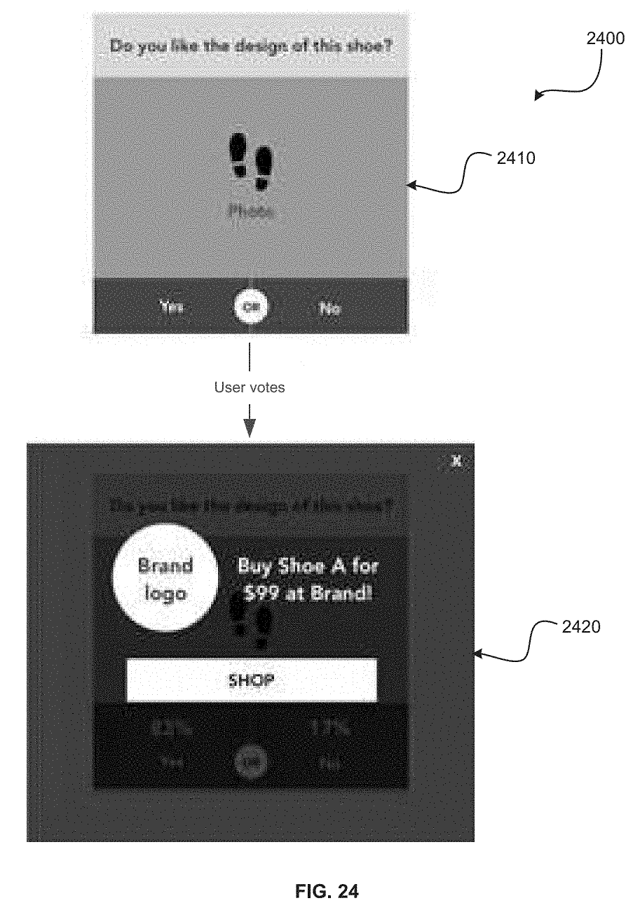

FIG. 24 two screen shots of a polling ad unit having a post-vote action of a brand-focused purchase that overtakes the screen of the user, in accordance with embodiments. In particular, FIG. 24 comprises screen shots 2410, 2420 of a polling pair of the polling ad unit 2400. In particular screenshot 2410 illustrates a query, “Do you like the design of this shoe?” The query has a generalized image of a shoe, as well as a first and second option of “Yes” and “No,” respectively. The generalized image may be replaced with other images associated with a shoe. Once a user selects an option, a post-vote action is displayed in screenshot 2420. In particular, screenshot 2420 illustrates a brand-focused purchase opportunity, as well as an opportunity to shop for the particular brand-focused purchase. As seen in screenshot 2420, a purchase opportunity is provided for a particular “Shoe A” at a particular price “$99.” This purchase opportunity takes up the complete screen of the user's mobile electronic device. Additionally, the “Shop” option provided may link through to a website that sells the particular advertised product (e.g., “Shoe A”) for the particular advertised price (e.g., “$99”).

### Computer Systems

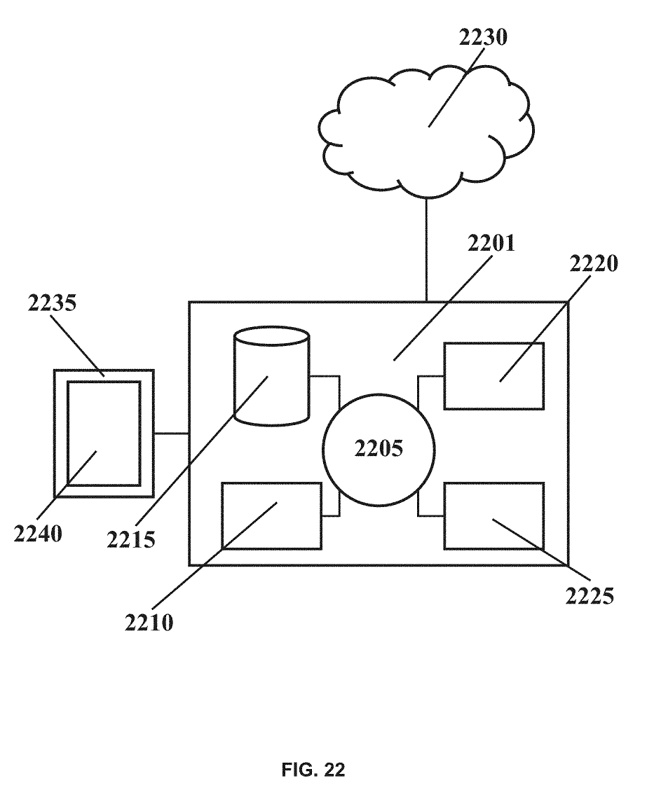

The present disclosure provides computer control systems that are programmed to implement methods of the disclosure. FIG. 22 shows a computer system 2201 that is programmed or otherwise configured to facilitate a polling ad unit and the exchange of queries and responses to the queries between users and the polling ad unit. The computer system 2201 can regulate various aspects of polling sessions, queries, and post-vote actions of the present disclosure, such as, for example, enabling users to prepare queries, direct the queries to other users, and receive responses to the queries.

The computer system 2201 includes a central processing unit (CPU, also “processor” and “computer processor” herein) 2205, which can be a single core or multi core processor, or a plurality of processors for parallel processing. The computer system 2201 also includes memory or memory location 2210 (e.g., random-access memory, read-only memory, flash memory), electronic storage unit 2215 (e.g., hard disk), communication interface 2220 (e.g., network adapter) for communicating with one or more other systems, and peripheral devices 2225, such as cache, other memory, data storage and/or electronic display adapters. The memory 2210, storage unit 2215, interface 2220 and peripheral devices 2225 are in communication with the CPU 2205 through a communication bus (solid lines), such as a motherboard. The storage unit 2215 can be a data storage unit (or data repository) for storing data. The computer system 2201 can be operatively coupled to a computer network (“network”) 2230 with the aid of the communication interface 2220. The network 2230 can be the Internet, an interne and/or extranet, or an intranet and/or extranet that is in communication with the Internet. The network 2230 in some cases is a telecommunication and/or data network. The network 2230 can include one or more computer servers, which can enable distributed computing, such as cloud computing. The network 2230, in some cases with the aid of the computer system 2201, can implement a peer-to-peer network, which may enable devices coupled to the computer system 2201 to behave as a client or a server.

The CPU 2205 can execute a sequence of machine-readable instructions, which can be embodied in a program or software. The instructions may be stored in a memory location, such as the memory 2210. Examples of operations performed by the CPU 2205 can include fetch, decode, execute, and writeback.

The storage unit 2215 can store files, such as drivers, libraries and saved programs. The storage unit 2215 can store programs generated by users and recorded sessions, as well as output(s) associated with the programs. The storage unit 2215 can store user data, e.g., user preferences and user programs. The computer system 2201 in some cases can include one or more additional data storage units that are external to the computer system 2201, such as located on a remote server that is in communication with the computer system 2201 through an intranet or the Internet.

The computer system 2201 can communicate with one or more remote computer systems through the network 2230. For instance, the computer system 2201 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 2201 via the network 2230.

Methods as described herein can be implemented by way of machine (e.g., computer processor) executable code stored on an electronic storage location of the computer system 2201, such as, for example, on the memory 2210 or electronic storage unit 2215. The machine executable or machine readable code can be provided in the form of software. During use, the code can be executed by the processor 2205. In some cases, the code can be retrieved from the storage unit 2215 and stored on the memory 2210 for ready access by the processor 2205. In some situations, the electronic storage unit 2215 can be precluded, and machine-executable instructions are stored on memory 2210.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 2201, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 2201 can include or be in communication with an electronic display 2235 that comprises a user interface (UI) 2240 for providing, for example, a chat session and facilitating the exchange of queries and responses to the queries between users. Examples of UP s include, without limitation, a graphical user interface (GUI) and web-based user interface.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for providing polls having linked post-vote actions, the method comprising:
presenting, on a user interface (UI) of an electronic device of a user, a polling query having two or more options, wherein each option presented is linked to a post-vote action;
receiving, on the electronic device of the user, a selection of an option from the two or more options in the polling query;
determining a post-vote action that is linked to the selected option, wherein the post-vote action is selected from the group consisting of (1) read more, (2) purchase, (3) clip coupon, (4) watch video, (5) click through to website, and (6) lead generation; and
presenting the post-vote action that is linked to the selected option on the UI of the electronic device of the user.

2. The method of claim 1, wherein the post-vote action is linked to content of the selected option.

3. The method of claim 1, wherein the post-vote action is based on the user's previous browsing history.

4. The method of claim 1, further comprising:
receiving user information in response to presenting the post-vote action.

5. The method of claim 1, wherein the polling query asks a user to select an option associated with a particular product that the user prefers from a plurality of options, each option of the plurality of options associated with a particular product.

6. The method of claim 5, wherein the post-vote action associated with the selected option presents a website to purchase the product associated with the selected option.

7. The method of claim 5, wherein the polling query is based on a geographical location or demographics associated with the user.

8. The method of claim 1, wherein the read more post-vote action comprises a presentation of one or more supplementary content.

9. The method of claim 1, wherein the read more post-vote action comprises a presentation of one or more links to supplementary content.

10. The method of claim 1, wherein the purchase post-vote action comprises an offer to purchase an item, wherein the offer to purchase an item is selected from the group consisting of an offer to purchase an item that is associated with the selected option, an offer to purchase an item where the offer is a direct offer presented on the user interface, and an offer to purchase an item where the offer is a link to an offer to purchase the item.

11. The method of claim 1, wherein the clip coupon post-vote action comprises a coupon, wherein the coupon is selected from the group consisting of a coupon that is a direct coupon presented on the user interface, a coupon that is a link to the coupon presented on the user interface, and a coupon that is an electronic coupon presented on the user interface.

12. The method of claim 1, wherein the watch video post-vote action comprises a video that is selected from the group consisting of a video that is a direct video presented on the user interface and a video that is a link to the video presented on the user interface.

13. The method of claim 1, wherein the click through to website post-vote action comprises a website, wherein the website is selected from the group consisting of a website that is a direct website presented on the user interface and a website that is a link to a website presented on the user interface.

14. The method of claim 1, wherein the lead generation post-vote action comprises an input box presented on the user interface.

15. The method of claim 14, wherein the input box may be used to request a user's e-mail address or phone number.

16. The method of claim 1, wherein the two or more options are photo images.

17. The method of claim 1, wherein the method is a computer-implemented method.

18. A method for providing polls having linked post-vote actions, the method comprising:
receiving a location associated with an electronic device of a user;
presenting, on a user interface (UI) of the electronic device of the user, a polling query having two or more options, wherein each option presented is linked to a post-vote action;
receiving, on the electronic device of the user, a selection of an option from the two or more options in the polling query;
determining a post-vote action that is linked to the selected option, wherein the post-vote action is determined based on 1) the received location associated with the electronic device of the user and 2) demographic data associated with the users; and
presenting the post-vote action that is linked to the selected option on the UI of the electronic device of the user.

19. The method of claim 18, wherein the method is a computer-implemented method.

20. A method for providing tailored post-vote actions to a user, the method comprising:
receiving, on the electronic device of the user, a selection of an option from a plurality of options associated with a polling query, wherein each option associated with the polling query is linked to a distinct post-vote action;
determining a post-vote action that is linked to the selected option; and
presenting the post-vote action that is linked to the selected option on the user interface (UI) of the electronic device of the user.
